(19) United States
(12) Patent Application Publication
(10) Pub. No.: US 2020/0041207 A1
(43) Pub. Date: Feb. 6, 2020

(54) SIDE WALL OF A PALLET CAR FOR A TRAVELLING GRATE MACHINE, PALLET CAR COMPRISING SUCH A SIDE WALL AND METHOD FOR CONVERTING A PALLET CAR

(71) Applicants: PAUL WURTH S.A., Luxembourg (LU); PAUL WURTH DEUTSCHLAND GMBH, Wiesbaden (DE)

(72) Inventors: Andrej SCHULAKOW-KLASS, Wiesbaden (DE); Mirko MÜLLER, Luxembourg (LU); Georg STRÜBER, Itzig (LU); Mathias HOFFMANN, Senningerberg (LU)

(21) Appl. No.: 16/478,499

(22) PCT Filed: Jan. 16, 2018
(86) PCT No.: PCT/EP2018/050995

§ 371 Date: Jul. 17, 2019

(30) Foreign Application Priority Data
Jan. 17, 2017 (EP) 17151839.2

(51) Int. Cl. F27B 21/06; F27B 9/26; F27D 3/12

(52) U.S. Cl. CPC F27B 21/06; F27D 3/123; F27B 9/262

(57) ABSTRACT

A side wall of a pallet car for a travelling grate machine including an upright portion, a wing portion and a lower connection flange, where the wing portion has an upper surface acting as an extension of a loading surface of the pallet car, the upper surface of the wing portion being arranged at an angle with respect to the horizontal.

### TECHNICAL FIELD

The present disclosure generally relates to pallet cars of travelling grate machines for thermally treating bulk material such as e.g. iron ore or zinc ore. More particularly, the present disclosure relates to a side wall and method for converting existing pallet cars into pallet cars having larger capacity.

### BACKGROUND

Travelling grate machines are generally well known in sintering or pelletizing plants, wherein bulk material is subjected to thermal treatment. Travelling grate machines comprise a plurality of pallet cars with which receive bulk material from a feed means. The pallet cars travel on a horizontally extending top strand through at least one treatment station wherein air is vertically fed through the pallet car and through the bulk material. At the end of the upper strand, the thermally treated bulk material is dumped by gravity from the pallet cars, which then travel upside-down back to the front end of the travelling grate machine. One example of such a travelling grate machine may be seen in U.S. Pat. No. 6,523,673.

Pallet cars have a perforate floor made up of individual grate bars having spaces therebetween to permit the passage of air, either in a downward direction or in an upward direction, depending on the treatment station. The air passes through the perforate floor and through the bulk material. The pallet cars are made up of a car body upon which the grate bars are fitted. Side walls are located at each transversely spaced side of the pallet cars to prevent spillage of the bulk material outwardly from the sides of the pallet cars. Each pallet car further has wheels for riding on guide rails along the traveling grate machine so that the individual pallet cars are in an abutting relationship to form a continuous moving perforate floor for the bulk material.

Due to the severe environment of the traveling grate machine, routine maintenance is required on the pallet cars. The grate bars, in particular, suffer a lot of damage and thus need replacement in order not to negatively impact on the process of thermally treating bulk material. Locking devices have been developed wherein downholders, such as e.g. rods or the like, are fed through the end casting of the car body and engage with the grate bars to maintain them in place. When the locking device is retracted, the grate bars can easily and quickly be replaced.

Over the years, there has been a desire to increase the capacity of travelling grate machines. This can of course be achieved by providing wider pallet cars. Such wider pallet cars have a larger loading surface and can thus carry more bulk material.

KR 10-0843912 discloses a converted pallet car with an extension mounted on the car body for moving the side wall further out. The space between the existing grate bars and the newly placed side wall is provided with a cover plate. The loading surface is thus no longer confined to the grate bars of the perforate floor, but also includes the cover plates. Thus, the loading surface is increased and the amount of bulk material deposited onto the pallet cars is also increased. It should be noted, however, that the cover plates are not permeable and any airflow through the bulk material is reduced in the corner of the cover plate and the side wall thereby creating so-called dead zones. Consequently, the thermal treatment of the bulk material is, in such dead-zones, not sufficient.

In an attempt to improve the thermal treatment of the bulk material on the extended area, EP 1 725 821 suggests modifying the car body by providing the lateral wall of the car body with an upper portion that extends outwardly. This however requires replacing all of the pallet cars, thereby increasing conversion costs. Furthermore, although the dead-zone may be reduced, it is not eliminated.

One of the major disadvantages of both KR 10-0843912 and EP 1 725 821 is that the downholders, which engage with the grate bars, are no longer easily accessible. Consequently, the replacement of the grate bars becomes a difficult and lengthy process. Improper grate bar maintenance may lead to increased wear of the grate bars, to damage to process equipment and to lower production efficiency.

### BRIEF SUMMARY

The disclosure provides an improved side wall for converting existing pallet cars into pallet cars having larger capacity without however having the disadvantages of some prior art attempts.

The disclosure further provides an improved converted pallet car.

The disclosure further provides an improved method for converting a pallet car.

The present disclosure provides a side wall of a pallet car for a travelling grate machine. According to the present disclosure, the side wall comprises an upright portion, above a wing portion and a lower connection flange. The wing portion has an upper surface acting as an extension of a loading surface of the pallet car, the upper surface of the wing portion being arranged at an angle with respect to the horizontal.

Such a side wall not only has the merit of increasing the loading area of the pallet car and thus the capacity of the travelling grate machine, it also further increases the quality of the thermal treatment in the lateral areas of the pallet car. Indeed, the wing portion is configured to directly support bulk material thereon. Due to the upper surface of the wing portion being arranged at an upward angle with respect to the horizontal, the so called dead zone in the extended loading area is reduced. The flow of air through the bulk material in that area is optimized and the quality of the thermally treated bulk material is improved.

Additional advantages are a reduction of spillage and dust production during the heat treatment of the bulk material because of improved air flow conditions through the removal of the dead zone. Indeed, a typical problem of existing widening solutions such as e.g. the one described in KR 10-0843912 is a substantial increase of dust and spillage after widening. The improved air flow also leads to a reduced wear of the grate bars in the area close to the extension.

Preferably, the angle with respect to the horizontal is in the range between 2° and 70°, more preferably between 5° and 45°, more preferably between 5° and 20°, and most preferably between 10° and 25°.

The upright portion, the wing portion and the lower connection flange are formed in one piece. In prior art solutions, additional wear parts are necessary to protect sensitive areas of the construction, such as bolts or joints between various parts. The side wall according to the present disclosure does not require such additional wear plates as the surface exposed to the bulk material is continuous. This helps lower the weight of the pallet car and also reduces maintenance needs and costs.

A junction between the upright portion and the wing portion may be rounded off; thereby further optimizing air flow through the bulk material in the extended loading area.

The side wall may be formed by at least one lower section and at least one upper section, the lower section comprising the lower connection flange, the wing portion and the upright portion. The upright portion may comprise an upper connection flange for connecting an upper section of the side wall thereto, the upper section forming an extension to the upright portion. Such side wall extensions increase the height of the loading area, thereby increasing the amount of bulk material that can be exposed to thermal treatment. Preferably, the side wall comprises more than one lower section and more than one upper section. Indeed, the number of lower sections for the overall width of the pallet car may be different than the number of upper sections. Typically, one side wall of a pallet car may e.g. have two lower sections, which may have three upper sections connected thereto. A staggered arrangement of these upper and lower sections reinforces the overall structure of the side wall.

According to a first embodiment of the present disclosure, the lower connection flange is essentially horizontal and extends back underneath the wing portion forming a groove between the wing portion and the lower connection flange. This provides a compact layout of the wing portion and the lower connection flange, while providing a groove that may be used for accessing bolts used to connect the lower connection flange to the car body of the pallet car.

The lower connection flange comprises a bore hole for connecting the side wall to the pallet car, the bore hole being accessible through the groove. While providing the connection of the side wall to the pallet car through the groove, the bolt used for achieving this connection remains accessible from the outside, thereby considerably facilitating maintenance of the pallet car. Previous solutions have suggested arranging the bolts on the inner side of the pallet car with the bolts therefore directly exposed to the bulk material. Due to the harsh conditions, the bolts often become very difficult, if not impossible, to loosen, even if cover plates are provided in an attempt to protect the bolts.

The lower connection flange preferably comprises at least one essentially horizontal bore hole for receiving therethrough at least one downholder of a locking device for grate bars of the pallet car. The locking device remains accessible from the outside even with the side wall in place. Thus, the holding device may be removed without the necessity of first removing the side wall. Easy maintenance of the grate bars of the pallet car can be achieved. Also, the holding device of the present disclosure may be similar to the holding device used for an existing pallet car, i.e. a pallet car which has not had its loading surface increased by replacing the side walls. The same type of grate bars and holding devices can be used on the widened pallet cars. This of course leads to lower investment required to convert existing pallet cars.

According to a second embodiment, for which protection is not sought, the lower connection flange is essentially vertical and engages a vertical projection on the pallet car. The vertical projection is preferably formed in one piece with an end casting of the pallet car. The lower connection flange comprises a bore hole for connecting the side wall to the vertical projection of the pallet car.

The side wall may further comprise at least one strengthening rib connected to an underneath of the wing portion, the strengthening rib being shaped such that, when the side wall is mounted, it comes into contact with an upper side of the end casting and a lateral portion of the vertical projection. The vertical projection may be sandwiched between the lower connection flange and the strengthening rib(s).

The lower connection flange and the vertical projection comprise at least one essentially horizontal bore hole for receiving therethrough at least one downholder of a locking device for grate bars of the pallet car.

The present disclosure also concerns a pallet car for a travelling grate machine, wherein the pallet car comprises a car body with wheels for travelling on rails of the travelling grate machine and a perforate floor arranged on the car body, the being perforate floor formed by a plurality of grate bars, the perforate floor being configured as a loading surface for bulk material. According to the present disclosure, the pallet car further comprises a side wall as described above, wherein the wing portion of the side wall has an upper surface acting as an extension of the loading surface of the pallet car.

Furthermore, the present disclosure concerns a method for converting a pallet car of a travelling grate machine comprising the steps of removing an original side wall of the pallet car and mounting a side wall as described above onto the pallet car.

The method preferably comprises removing a locking device from the pallet car before removing the original side wall, the locking device comprising downholders engaging the grate bars. The method preferably also comprises reinstalling the locking device after mounting the above described side wall onto the pallet car.

### BRIEF DESCRIPTION OF THE DRAWINGS

Preferred embodiments of the disclosure will now be described, by way of example, with reference to the accompanying drawings, in which:

FIG. 1 is a perspective view of a pallet car according to a first embodiment of the present disclosure;

FIG. 2 is an enlarged cross-sectional view through a side wall of the pallet car of FIG. 1;

FIG. 3 is a perspective view of a lower section of the side wall of FIG. 2;

FIG. 4 is a cross-sectional view through the lower section of FIG. 3 at the level of the connection bore;

FIG. 5 is a cross-sectional view through the lower section of FIG. 3 at the level of the bore hole for the grate bar locking device;

FIG. 6 is a perspective view of a grate bar locking device of FIG. 1.

FIG. 7 is a perspective view of a pallet car according to a second embodiment, for which protection is not sought; and

FIG. 8 is an enlarged cross-sectional view through a side wall of the pallet car of FIG. 7.

### DETAILED DESCRIPTION

The general layout and functioning of a travelling grate machine, as e.g. used in sintering or pelletizing plants, is well known such as for example from U.S. Pat. No. 6,523,673 and is thus not repeated herein.

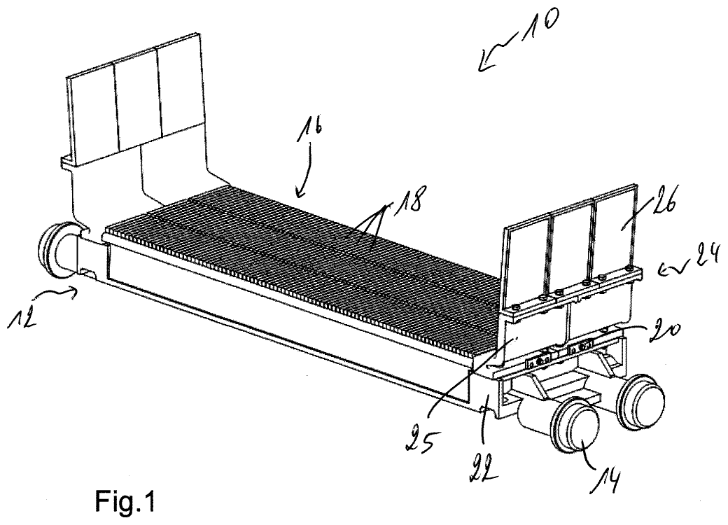

FIG. 1 shows a pallet car 10 according to a first embodiment of the disclosure. Such a pallet car 10 comprises a car body 12 with wheels 14 travelling on rails (not shown) of the travelling grate machine. The top of the car body 12 comprises a perforate floor 16 for supporting the bulk material to be treated thereon. The perforate floor 16 is formed by a plurality of grate bars 18 arranged with spaces therebetween to permit the passage of air, either in a downward direction or in an upward direction. The grate bars 18 are maintained in place by means of a locking device 20 passing through an end casting 22 of the car body 12 and engaging the grate bars 18 from below.

A windbox (not shown) may e.g. be located below the pallet car 10 for feeding hot air either upwards or downwards through the pallet car 10. The hot air passes through the spaces between the grate bars 18 and traverses the bulk material (not shown) arranged on the pallet car 10. In sinter plants, hot air is sucked through the windbox in a downward direction, i.e. the hot air traverses the bulk material from top to bottom. In pellet plants, on the other hand, there are sections in which hot air is sucked through the windbox in a downward direction and sections in which hot air is blown through the windbox in an upward direction.

A side wall 24 is connected to the end casting 22 of the car body 12 to form a retainer wall for the bulk material deposited onto the pallet car 10. Such a side wall 24 may comprise one or more lower sections 25 and one or more upper sections 26, wherein the upper sections 26 increase the height of the side wall 24.

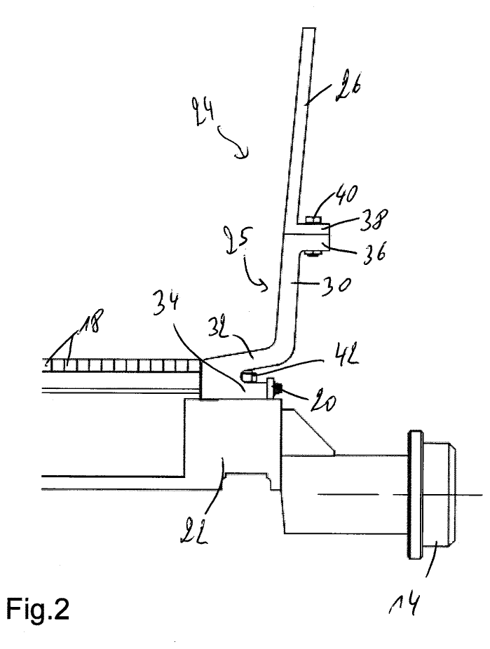

As shown in FIG. 2, a side wall 24 of the first embodiment of the disclosure, in particular, a lower section 25 thereof, is configured to have an elbow shape comprising an upright portion 30, a wing portion 32 and a lower connection flange 34. The wing portion 32 acts as an extension of the loading surface formed by the perforate floor 16, thereby increasing the loading capacity of the pallet car 10. The upright portion 30 shown herein comprises an upper connection flange 36 for receiving a connection flange 38 of the upper section 26 thereon. The flanges 36, 38 may be connected together using bolts 40 or the like. The lower connection flange 34 is essentially horizontal and configured to be connected to the end casting 22 of the car body 12 by means of bolts 42 or the like.

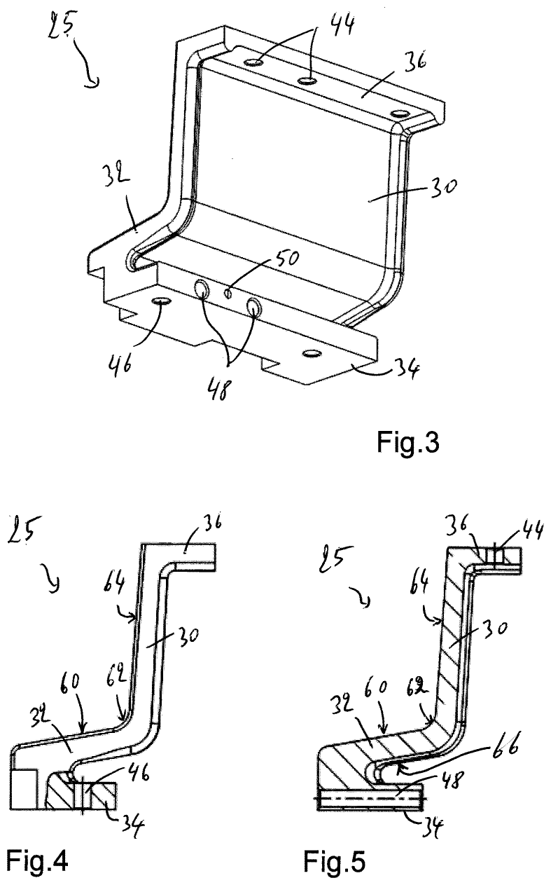

The side wall of the first embodiment shown in FIG. 2 is more closely described by referring to FIGS. 3, 4 and 5.

FIG. 3 shows a perspective view of the side wall 24 of FIG. 2. As can be seen, the upper connection flange 36 comprises bore holes 44 for allowing bolts to pass therethrough to connect the upper section 26 to the lower section 25. Similarly, the lower connection flange 34 comprises bore holes 46 for allowing bolts to pass therethrough to connect the lower section 25 of the side wall 24 to the end casting 22 of the car body 12. Furthermore, the lower connection flange 38 comprises bore holes 48 for the locking device 20 and a bore hole 50 for connecting the locking device 20 thereto.

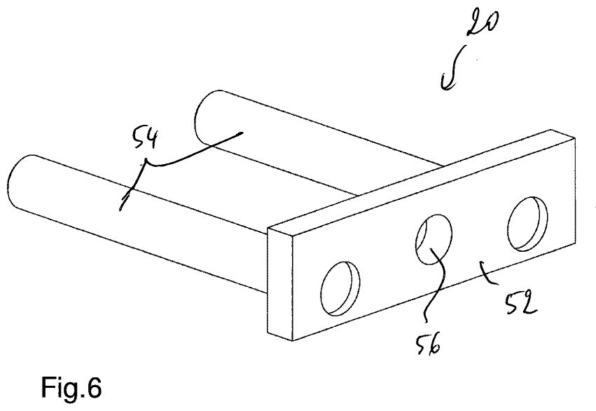

A preferred embodiment of the locking device 20 for the grate bars 18 is more closely described by referring to FIG. 6. The locking device 20 comprises a connection plate 52 comprising, in this embodiment, two parallel downholders 54 which are designed to pass through the bore holes 48 of the lower connection flange 38 and through bore holes (not shown) in the end casting 22 of the car body. The downholders 54 cooperate with connection elements of the grate bars 18 to maintain the latter in place. The removal of the locking device 20 disengages the downholders 54 from the connection elements of the grate bars 18 and allows the latter to be removed and replaced. In order to maintain the locking device 20 in place, the connection plate 52 further comprises a through hole 56 for passing a pin or the like therethrough for connecting to the bore hole 50 of the lower connection flange 38 of the side wall 24.

The particular shape of the side wall 24 will now be more closely described by referring back to FIGS. 4 and 5.

As clearly seen on these figures, the upper surface 60 of the wing portion 32 is not horizontal, but arranged at an angle with respect to the horizontal. This angle is preferably in the range between 2° and 70°, more preferably between 5° and 45°, more preferably between 5° and 20°, and most preferably between 10° and 25°. Due to the angle of the upper surface 60 of the wing portion 32, the dead-zone in the corner 62 between wing portion 32 and upright portion 30 can be minimized.

Also, the upright portion 30 has an inner surface 64, i.e. the surface facing the bulk material, that is not vertical, but arranged at a slight angle with respect to the vertical. This angle is generally dependent on the existing pallet car structure and may be maintained as per the original design. Typically, however, this angle is in the region of about 3°.

According to the embodiment shown in FIGS. 4 and 5, the side wall comprises an essentially horizontal lower connection flange 34, essentially extending back underneath the wing portion 32. A narrow groove 66 is formed between the wing portion 32 and the lower connection flange 34. Such a groove 66 allows for the lower connection flange 34 to be bolted to the end casting 22 of the car body 12 through bore hole 46. One of the major advantages thereof is that the bolts (visible on FIG. 2) remain accessible from the outside of the pallet car 10, thereby allowing easy access for maintenance reasons.

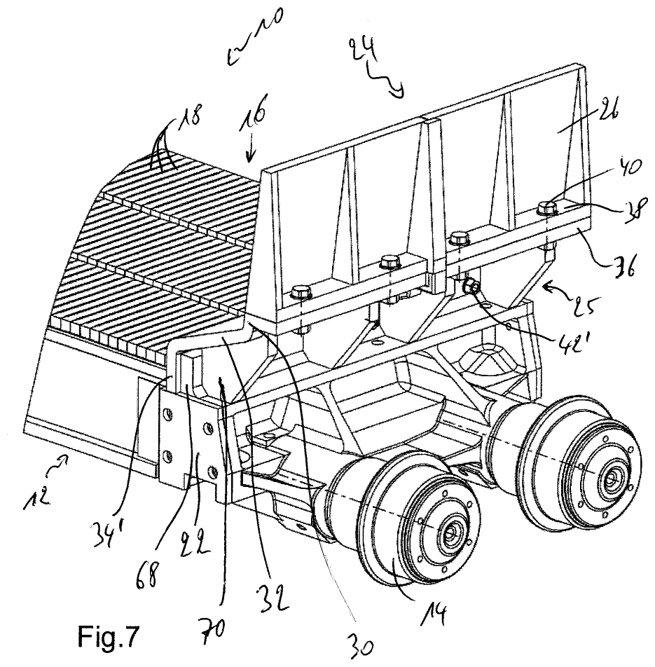

FIG. 7 shows a portion of pallet car 10 according to a second embodiment, for which protection is not sought. Such as in the first embodiment, the pallet car 10 comprises a car body 12 with wheels 14 travelling on rails (not shown) of the travelling grate machine. The top of the car body 12 comprises a perforate floor 16 for supporting the bulk material to be treated thereon. The perforate floor 16 is formed by a plurality of grate bars 18 arranged with spaces therebetween to permit the passage of air, either in a downward direction or in an upward direction. The grate bars 18 are maintained in place by means of a locking device (not shown).

Also, such as according to the first embodiment, the side wall 24 of the second embodiment of the disclosure, in particular, a lower section 25 thereof, comprises an upright portion 30, a wing portion 32 and a lower connection flange 34′. The upright portion 30 comprises an upper connection flange 36 for receiving a connection flange 38 of the upper section 26 thereon. The flanges 36, 38 may be connected together using bolts 40 or the like. The lower connection flange 34′ is essentially vertical and configured to be connected to a vertical projection 68 of the end casting 22 of the car body 12 by means of bolts 42 or the like. The locking device passes through the lower connection flange 34′ and the vertical projection 68 to engage the grate bars 18 from below. Alternatively, the locking device passes through an end casting 22 of the car body 12 to engage the grate bars 18 from below.

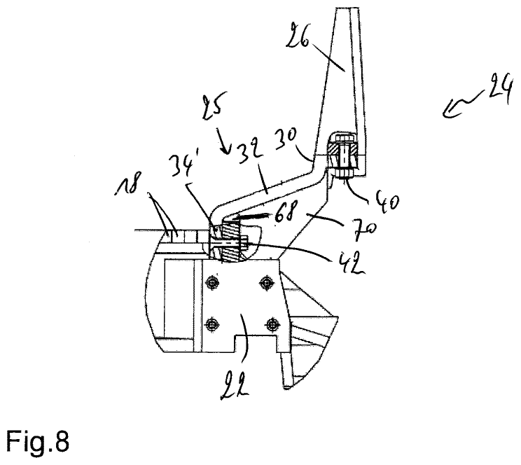

The side wall of the second embodiment shown in FIG. 7 is more closely described by referring to FIG. 8.

The end casting 22 of the second embodiment comprises a vertical projection 68 on the upper side thereof. The vertical projection 68 is preferably formed in one piece with the end casting 22.

The side wall 24, more particularly the lower section 25 thereof has a lower connection flange 34′ which is essentially vertical and arranged alongside the vertical projection 68. Both the lower connection flange 34′ and the vertical projection 68 comprise boreholes therethrough for connecting the lower connection flange 34′ to the vertical projection 68 by means of bolts 42 or the like.

Preferably, the lower section 25 of the side wall 24 further comprises one or more strengthening ribs 70 connected to the underneath of the wing portion 32. The strengthening ribs 70 are shaped such that, when the lower section 25 is connected to the end casting 22, they come into contact with the upper side of the end casting 22 and the lateral portion of the vertical projection 68 such that the vertical projection 68 is sandwiched between the lower connection flange 34′ and the strengthening ribs 70.

Further details and features of the side wall 24 of the second embodiment are similar or identical to the ones of the first embodiment and are thus not repeated herein.

1. A side wall of a pallet car for a travelling grate machine, said pallet car comprising a car body carrying a perforate floor configured as a loading surface for bulk material, said side wall forming a retainer for said bulk material
wherein said side wall is configured to have an elbow shape comprising an upright portion above a wing portion and a lower connection flange below said wing portion, said upright portion, said wing portion and said lower connection flange being formed in one piece;
wherein said lower connection flange is essentially horizontal and extends back underneath said wing portion forming a groove between said wing portion and said lower connection flange;
wherein said wing portion has an upper surface acting as an extension of a loading surface of the pallet car, said upper surface of said wing portion being arranged at an angle with respect to the horizontal; and
wherein said lower connection flange comprises a bore hole accessible from outside the pallet car for connecting said side wall to said pallet car, and said wing portion extends over said bore hole.

2. The side wall according to claim 1, wherein said lower connection flange comprises at least one bore hole accessible from outside the pallet car for receiving therethrough a locking device for grate bars of said perforate floor.

3. The side wall according to claim 1, wherein said angle with respect to the horizontal is in the range between 2° and 70°.

4. The side wall according to claim 1, wherein said side wall comprises at least one lower section and at least one upper section, the lower section comprising said lower connection flange, said wing portion and said upright portion, wherein said lower section comprises an upper connection flange for connecting said upper section thereto, said upper section forming an extension to said upright portion.

5. The side wall according to claim 4, wherein said bore hole is accessible through said groove.

6. The side wall according to claim 1, wherein said lower connection flange comprises at least one essentially horizontal bore hole for receiving therethrough at least one downholder of a locking device for grate bars of said pallet car.

7. A pallet car for a travelling grate machine, said pallet car comprising:
a car body with wheels for travelling on rails of said travelling grate machine,
a perforate floor arranged on said car body, said perforate floor being formed by a plurality of grate bars, said perforate floor being configured as a loading surface for bulk material,
a side wall according to claim 1.

8. A method for converting a pallet car of a travelling grate machine comprising the steps of:
removing an original side wall of said pallet car,
mounting a side wall according to claim 1 onto said pallet car.

9. The method according to claim 8, wherein said step of removing said original side wall of said pallet car comprises:
removing a locking device from said pallet car prior to removing said original side wall, said locking device comprising downholders engaging said grate bars.

10. The method according to claim 9, wherein said step of mounting said side wall onto said pallet car comprises the further step of reinstalling said locking device.

11. The side wall according to claim 3, wherein said angle with respect to the horizontal is in the range between 5° and 45°.

12. The side wall according to claim 3, wherein said angle with respect to the horizontal is in the range between 5° and 20°.

13. The side wall according to claim 3, wherein said angle with respect to the horizontal is in the range between 10° and 25°.
